(19) United States
(12) Patent Application Publication
(10) Pub. No.: US 2012/0296840 A1
(43) Pub. Date: Nov. 22, 2012

(54) INTERACTIVE GRAPHICAL TOOL FOR DESIGNING PRODUCT PARAMETERS

(76) Inventors: ANDREAS VOGEL, San Francisco, CA (US); Alexander Varshavsky, San Francisco, CA (US); Hariharan Vijayaraghavan, Chicago, IL (US)

(21) Appl. No.: 13/108,255

(22) Filed: May 16, 2011

(51) Int. Cl. G06Q 10/00

(52) U.S. Cl. 705/342

(57) ABSTRACT

Interactive graphical tool for designing product parameters where an initial correspondence between a number of product characteristics is displayed in a graphical user interface (GUI) pane. The form or the position, or both form and position, of the initial correspondence are changed in response to a user manipulation to a GUI control associated with the correspondence. One or more values of the number of characteristics are customized in response to the visual change of the correspondence between the product characteristics.

### BACKGROUND

One of the most important tasks in virtually every company is the definition of commodities, services or other products offered to clients. The definition of a product specifies parameters that are important for the customers. In one simple example, the definition of a product would be assigning a price to particular merchandise. However, even in this simple scenario, the task may get complex, e.g., the price may vary based on different factors, such as current promotions, discounts, region of sale, even day or time when the commodity is sold or consumed.

Generally, companies use complex software tools to define, design or re-design, and operate the offered or provided products. However, the specification of product parameters is typically a tedious job, usually done in spreadsheet-like interfaces. Often, the definition of a product is a process that requires many iterations of parameters specifications, market simulations, result analysis, etc., until best correspondence between the product characteristics is achieved. In the highly competitive environment that exists in current market economies, it could be critical for a company to be able to design or re-design its products in a faster and more efficient manner.

### SUMMARY

Various embodiments of systems and methods for interactive graphical tool for designing product parameters are described herein. According to one aspect, an initial correspondence between a number of product characteristics is displayed in a graphical user interface (GUI) pane. In another aspect, the form or the position, or both form and position, of the initial correspondence are changed in response to a user manipulation to a GUI control associated with the correspondence. One or more values of the number of characteristics are customized in response to the visual change of the correspondence. The values of the customized product characteristics are stored in memory. Various analytics are executed based on the customized product characteristics using historical data or forecasts.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a computer system where product parameters are designed analyzed and executed, according to one embodiment.

FIG. 2 illustrates a process for interactive design of product parameters, according to one embodiment.

FIG. 3 shows a GUI pane for designing product parameters, according to one embodiment.

FIG. 4 shows a GUI pane for designing product parameters, according to one embodiment.

FIG. 5 shows a GUI pane for designing product parameters, according to one embodiment.

FIG. 6 shows a GUI pane for designing product parameters, according to one embodiment.

FIG. 7 is a block diagram of an exemplary computer system to execute computer readable instructions for data lifecycle cross-system reconciliation, according to one embodiment of the invention.

### DETAILED DESCRIPTION

Embodiments of techniques for interactive graphical tool for designing product parameters are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

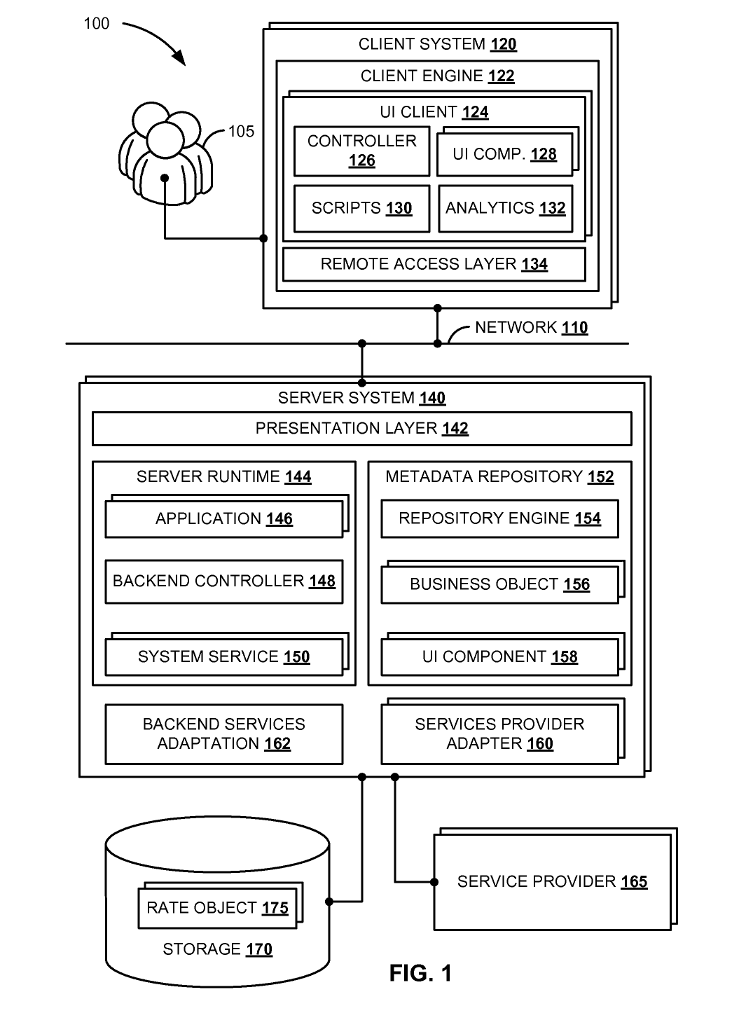

FIG. 1 is a block diagram showing computer system 100 where product characteristics are designed, analyzed and executed, according to one embodiment. The computer system 100 is a rather simplified example of classic client-server architecture. One or more shareholders or users 105, e.g., product designers, managers, etc., operate on one or more client systems 120. Users 105 may request different services or execute various operations available within client systems 120 or provided by one or more server systems 140 via network 110. The illustrated server systems 140 represent one or more backend nodes of the computer system 100. Some of the elements of the computer system 100 resemble the structure and functionality of software modules developed by SAP AG. However, other structures with similar functionalities could be found in software products developed by other vendors, as well. Alternative embodiments may utilize other kinds of computer system architectures.

The client systems 120 may have similar or different structures where one or more of the illustrated modules are replicated. One or more users 105 may operate within one or more instances of user interface (UI) client 124 of one or more of client systems 120. Different users 105 may access exclusively different instances of the UI client 124 within a same client system 120.

In one embodiment, any of client systems 120 may run a standalone client application, e.g., client engine 122, to interact with the backend server system 140. Alternatively, an intermediate layer may be downloaded to any of the client systems 120 as an extension of a running internet browser. This intermediate layer is also illustrated as client engine 122. The standalone client application and the intermediate layer may have similar components and functionality. Client engine 122 takes responsibility for rendering the necessary client functionality, and also for the communication with server system 140 via network 110 when necessary.

The client engine 122 includes UI client sessions 124 that may also embed into a browser integrated framework. The UI Client 124 may be a part of any popular browser integrated framework, e.g. Silverlight™ provided by Microsoft® Corp, Flex™ provided by Adobe® Systems Inc., JavaFX™ originally developed by Sun® Microsystems Inc., etc. In one embodiment, the client engine 122 and UI client 124, respectively, may be a desktop application, for example, a .NET™ application rendering a UI through a Windows Prosecution Foundation (WPF) system. The client runtime 124 accesses the necessary business data at the backend 140 through remote access layer 134 via network 110. In one embodiment, no dedicated UI server or client programs are needed. The communication with the backend 140 may include extracting, storing or updating data. The data may be transported to storage 170, especially when backend 140 is implemented on a number of server nodes.

In one embodiment, users 105 generate services requests at UI client 124. UI components module 128 instantiates one or more appropriate graphical user interface (GUI) screen or controls in response to the user request. The behavior of the UI components is managed by controller 126. The controller 126 makes sure that all instantiated controls in the UI components 128 are initialized. The controller is also responsible for the execution of any configured operation triggered by events corresponding to the instantiated controls. In case when some of the operations involve execution of script segments, the controller 126 may trigger the execution of these scripts via scripts module 130. In one embodiment, scripts module 130 is a frontend scripting engine. Analytics module 132 may be used for frontend data processing when necessary.

In one embodiment, the backend 140 utilizes presentation layer 142 to connect to the Internet or to another public or private network and provide access to business functions and data structures underlying the UI client sessions 124 of client systems 120. For example, the presentation layer 142 may generate the UI object model underlying the UI controls instantiated in the UI components module 128 at the client systems 120. In one embodiment, presentation layer 142 may be part of the server runtime 144.

The server runtime 144 provides environment where one or more software applications 146 are executed. For example, the applications 146 may provide a number of business services for the users 105. Generally, various operation requests related to the business services are generated at the client systems 120, and translated to different process tasks performed by the applications 146 executed in the server runtime 144.

In one embodiment, the server runtime 144 generates backend controller 148 for one or more UI client sessions 124 to handle every requested UI component, e.g., when the UI client 124 triggers an initialization of a UI component for the first time in the session. The backend controller 148 manages the collaboration between the requested UI components and the underlying business objects. System services 150 in the server runtime 144 may be used to administer the characteristics of the server runtime 144, e.g., its engine parameters, the user access to its components, the processes execution, the communication with other runtime environments, like, external systems, databases, etc.

Metadata repository 152 is generally the place where metadata about the computer programs deployed in the server system 140 are preserved, according to one embodiment. There are different kinds of metadata that could be maintained by the metadata repository 152. For example, the repository 152 keeps the description of the business objects 156 underlying the applications 146. In one embodiment, metadata repository 152 keeps description of the available UI components 158 and the relationships between them as designed.

Repository engine 154 manages the metadata and the collaboration with the server runtime 144 at one hand, and with a number of service providers 165 at the other hand. The service providers 165 may render UI components to the backend 140 as defined in the metadata. The service providers 165 are available via service provider adapters 160, and can be either internal or external to the backend 140. Backend services adaptation 162 represents a layer that helps to adjust the designed UI or rendered UI components to a set of normalized business objects available at the server system 140, according to one embodiment.

In a multi server system environment, e.g., in a cluster of more than one server systems 140, storage 170 may be used to persist different kinds of data, including programming code, business data, metadata repository 152, etc.

In one embodiment, users 105 may design or re-define a product, a commodity, or other entity or business offering by manipulating the UI components 128 associated with particular characteristics of the product. The UI components 128 may be available within GUI environment of the UI client 124. The manipulations of the UI components 128 may trigger execution of various system or application procedures in server runtime 144. Further, the manipulations of the UI components 128 may lead to changes in the metadata repository 152, e.g., changes in the definitions of the UI components 158, changes in the descriptions of the business objects 156, etc.

For example, the manipulation of UI components may change the selling price of a product. The selling prices of the product could be kept in rate objects 175 in storage 170, where they are available for further management, calculations and analyses performed by different applications 146 and/or analytics 132. In one embodiment, the visual design of product characteristics performed at UI client 124 may lead to dynamic creation of pricing objects, e.g., business objects with data structure corresponding and functional dependencies matching the defined parameters.

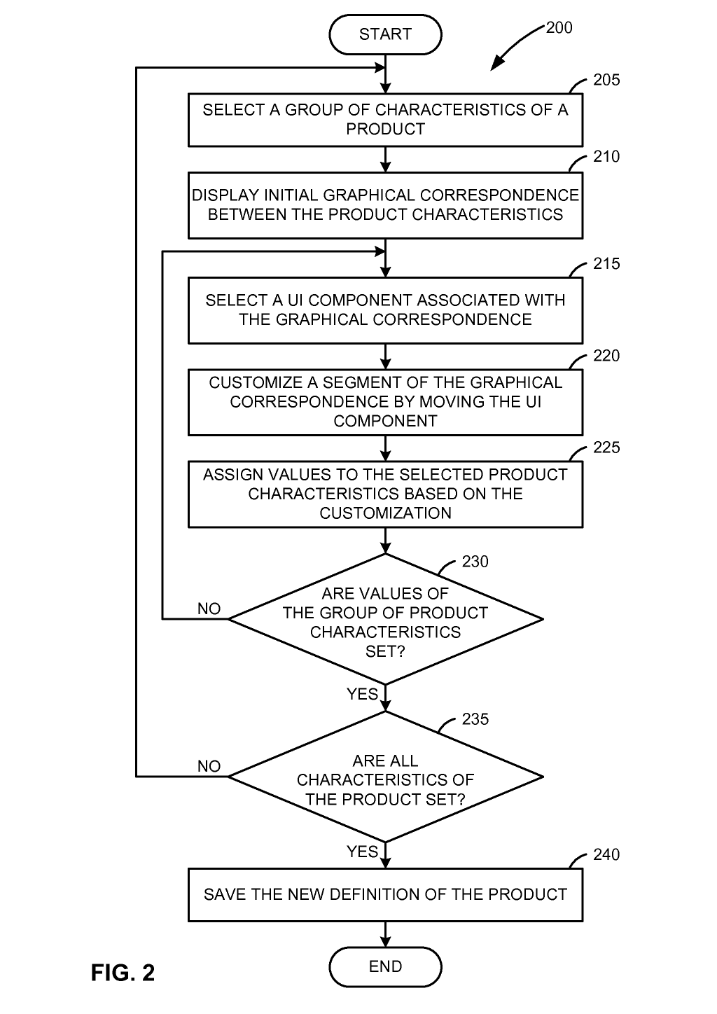

FIG. 2 shows process 200 for interactive design of product parameters, according to one embodiment. The definition of the parameters of different product characteristics may be performed within GUI environment with the help of different kinds of user interface devices, including keyboard, pointer devices (e.g., computer mouse, track ball, track pad, etc.), touch screen, etc. At 205, a group of product characteristics are selected for definition. The terms product characteristics and product parameters are used interchangeably in this document, and the broadest definition for the term product characteristic or parameter applies. At the same time, a group of product characteristics could mean a group of dimensions of a single product parameter. For example, the price characterizing a product may have “time of sell” and “price in dollars” dimensions. Respectively, all of the terms product characteristic, product parameter, and dimension of product characteristic or product parameter are used interchangeably in this document. Thus, at 205, a group of dimensions of a single product characteristic could be selected as well.

At 210, an initial graphical correspondence between the selected product characteristics is displayed. Generally, graphical correspondence means that a correlation between the selected product characteristics or the selected dimensions of a product characteristic is illustrated with graphical means, e.g., a chart, a diagram, etc. The initial correspondence may be a default or previously defined correlation between the selected product parameters.

At 215, a UI component associated with the initial graphical correspondence is selected. In one embodiment, the UI component is adjacent to the graphical correspondence and visible whenever the graphical correspondence is displayed or is active (e.g., in the focus of the GUI). In another embodiment, the UI component is displayed only in response to a predefined event. The position where the UI component is displayed may also depend on the event. For example, the UI component is displayed when a pointer of the GUI moves over a specific area of the graphical correspondence. The UI component may be displayed transparently and may get solid contours when the GUI pointer is placed directly above it or in a predefined proximity. The level of transparency of the UI component may change depending on the relative position of the GUI pointer.

In one embodiment, the selected UI component could be manipulated by a user, and the product characteristics may be changed in response to the received manipulation. At 220, a segment of the graphical correspondence is customized by moving the UI component within the displayed GUI. The position of the GUI component changes in response to user actions, e.g., via sliding pointer device, pressing arrow keys, gliding over touch controls, etc.

When the UI component moves, the associated graphical correspondence, or at least a segment of the graphical correspondence assigned to the UI control, changes accordingly. The graphical correspondence may be separated in several segments which correspond to different dependencies between the selected product characteristics. For example, the price of a product may be different on different days of the week, thus, the graphical correspondence between the price and the days of the week may be broken in several segments corresponding to the different price levels. The segmentation of the graphical correspondence may be a result of the user manipulation of the selected UI component. A separate UI component for customization may be associated with each existing or newly formed segment of the graphical correspondence.

Based on the customization, new values for the segment are assigned to the selected product characteristics to reflect the changed correlation between them at 225. At 230, a decision is taken whether the values of the selected group of product characteristics are set according to the user desires. If there are still values of the product characteristics (or product characteristic dimensions) that need to be set, or further customized, process 200 loops to 215 where another UI component associated with an the graphical correspondence is selected to define or customize an appropriate segment of the correspondence at 220. The actions of 215 through 225 are executed until it is verified at 230 that the values of the product characteristics are set.

At 235, another check is performed to verify if all characteristics of the product are set. The initially selected group of product characteristics at 205 may not be exhaustive for designing the product. Therefore, the process 200 loops to 205 where another group of parameters of the product is selected to be customized as described, when not all characteristics of the product are set. For example, quantity may represent another parameter of the product that needs to be defined or customized in correspondence with the product price, the time of sell or use, etc. Once it is verified at 235 that the product properties are set, the designed product definition is saved or stored for further analyses and processing at 240.

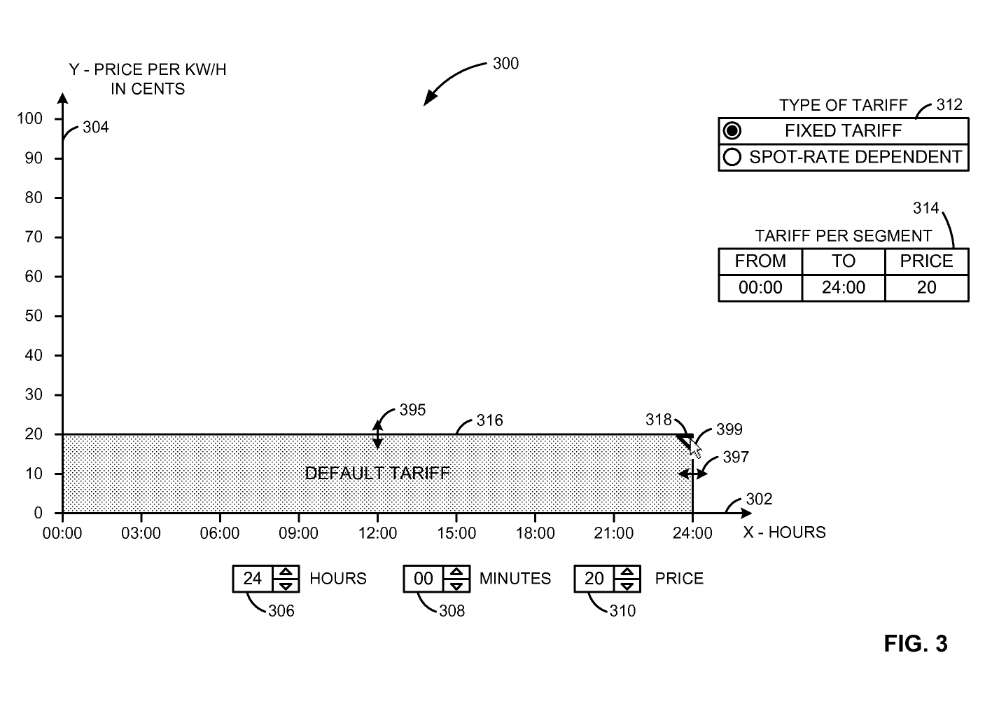

FIG. 3 shows GUI screen 300 where an exemplary and rather simplified environment for visually designing product parameters is presented, according to one embodiment. In the example of FIG. 3, the characteristics of product ‘electricity supply’ are customized. The first characteristic that may be defined by a user is the type of tariff that applies for pricing the electricity supply. In pane 312, the user may select either fixed tariff or spot-rate tariff, e.g., by clicking the corresponding option box. One of the most important characteristics of the product ‘electricity supply’ is the price of the delivered electricity. According to the provided example, the user selects fixed tariff for pricing the electricity supply.

The GUI 300 displays an initial correspondence between the price of the electricity and the time when it is supplied. In one embodiment, the correspondence is presented within a two-dimensional Cartesian coordinate system, where the time in hours is allocated along the X-axis, and the price of the supplied electricity in kW/hour in cents is allocated along the Y-axis. Initially, the fixed tariff is defined by a single segment with duration of 24 hours and price of 20 cents per kW/hour. The initial tariff including a single segment is shown in GUI 300 in table 314, and is graphically illustrated within the coordinate system by rectangle 316.

In one embodiment, there are several alternative ways to change the initial tariff. The length and assigned price per segment could be edited directly in table 314. Similarly, the length and the assigned price may be adjusted using UI controls 306, 308 and 310, where the hours 306 and minutes 308 specify when the current tariff segment ends, and price 310 shows the price assigned to the segment. Finally, a user may visually customize the correspondence between time and price by changing the dimensions of the rectangle 316. The rectangle 316 dimensions may be changed vertically along Y-axis by using UI control 395; horizontally along X-axis by using UI control 397; or both horizontally and vertically by dragging UI control 318 with pointer 399. The UI control 318 may be adjacent to the corner of the rectangle 316, according to one embodiment. UI controls 395 and 397 may appear when pointer 399 moves over the respective horizontal or vertical border of rectangle 316. In one embodiment, UI controls 395 and 397, when appear, replace the pointer display. UI control 318 may be permanently displayed or may be transparent when the pointer 399 is away.

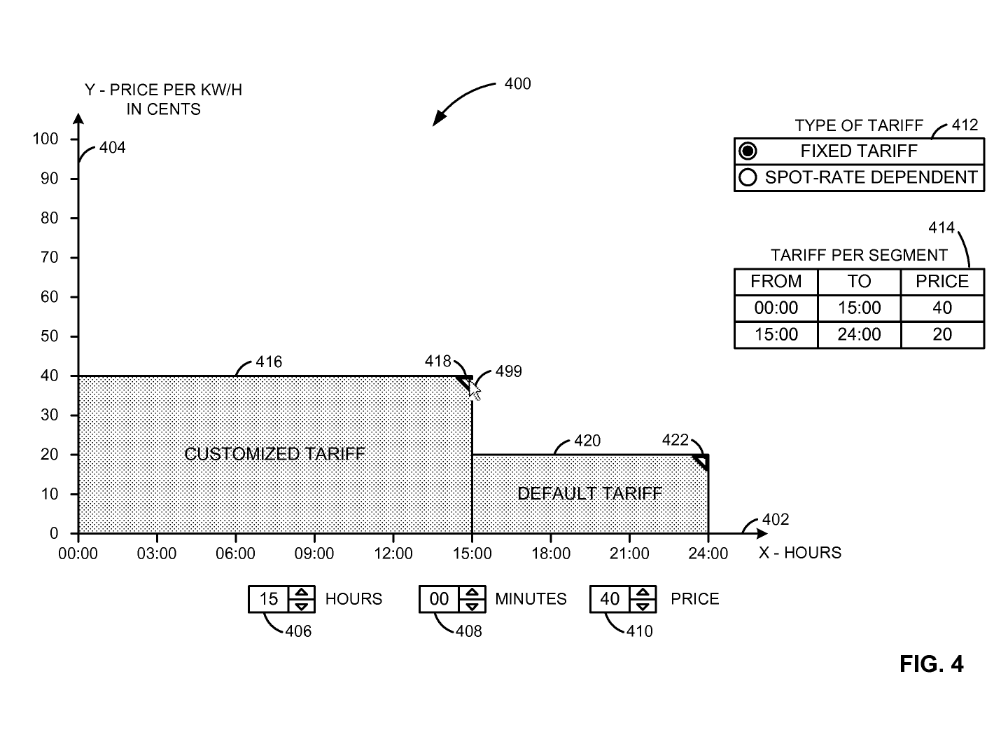

FIG. 4 shows GUI screen 400, where the default tariff illustrated in FIG. 3 has been modified. The GUI 400 has the structure of GUI 300 in FIG. 3. Again, hours are distributed along Y-axis 402, and the price in cents per kW/h in cents is along Y-axis 404. Fixed tariff option is selected in type of tariff UI control 412. However, an additional price segment is defined as illustrated with rectangles 416 and 420, and as specified in table 414. Rectangle 416 specifies customized tariff, which is created by dragging UI control 418 both vertically and horizontally. As a result, a segment of the fixed tariff is specified which starts at 00:00 o'clock, ends at 15:00 o'clock, and assigns 40 cents per kW/h for electricity supply.

The rectangle 420 shows that the tariff for the remaining segment between 15:00 o'clock and 24:00 o'clock keeps it default price of 20 cents per kW/h. Again, further customization of the tariff could be done by manipulating the table UI control 414 by adding new rows, deleting existing rows, or changing the rows values. The time duration and the price assigned to the current segment, e.g., rectangle 416, could be adjusted with UI controls 406, 408 and 410. The current segment 416 may be further customized by changing its vertical or horizontal size, including by moving the adjacent UI control 418 with pointer 499. New segment may be defined, or the assigned default price for the period from 15:00 o'clock to 24:00 o'clock may be changed by moving UI control 422 adjacent to rectangle 420.

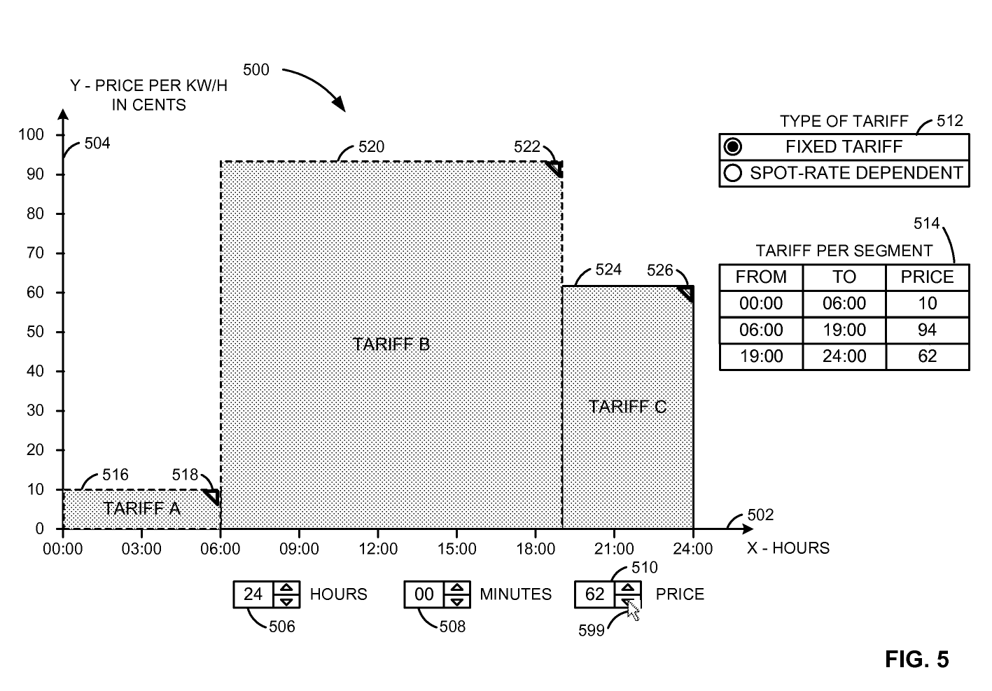

FIG. 5 shows GUI 500 where a customized flat tariff for electricity supply product is displayed. According to one embodiment, a user has used the available UI components associated with the correspondence between time of use and price per kW/h of the electricity to define three segments 516, 520 and 524 of the tariff. As it was shown in the previous two figures, the associated UI components include the tariff per segment table 514, where each tariff segment is presented as a separate row specifying its duration and assigned price. The set of UI controls 506, 508 and 510 form another UI component associated with the parameters of the electricity supply product. The UI controls 506, 508 and 510 can be used for precise manipulation of the characteristics of the current segment of the correspondence. As illustrated in FIG. 5, the pointer 599 is used to decrease the price of the supplied electricity for the last tariff segment. Alternatively, the values for hours 506, minutes 508 and price 510 may be directly entered, e.g., typed, similarly to as they can be entered in table 514. The current segment is illustrated with rectangle 524 drawn with solid contours. The tariff segments which are not in focus, e.g., rectangles 516 and 520, are drawn with dashed contours.

UI components or controls 518, 522 and 526 adjacent to rectangles 516, 520 and 524, respectively, can be used for visual tariff customization along both X-axis 502 and X-axis 504, according to one embodiment. The rectangles 516, 520 and 524 graphically illustrate the correspondence between the tariff hours and the assigned price per kW/h in cents. Alternatively, the rectangles 516, 520 and 524 could be resized by moving their borders horizontally along X-axis 502 and vertically along Y-axis 504. In one embodiment, when the last rectangle on the right along X-axis 502 (rectangle 524 as illustrated in FIG. 5) is resized in leftward direction, e.g. narrowed, a new tariff segment will be automatically included for the time remaining to 24:00 o'clock specifying a default or predefined price rate.

The visual design of product parameters as described with FIG. 3, FIG. 4 and FIG. 5, according with process 200 of FIG. 2 allows fast and efficient customization of the product characteristics. Once the user is ready with the customization, the product characteristics, e.g., price rates, time of use, etc. can be saved and stored for further use and analysis. For example, a different statistics could be generated based on the designed parameters using historical data or forecasted information. In one embodiment, the generation of statistical analyses may be generated automatically when a correspondence segment is changed. Thus, users may adjust the product definitions based on immediate feedback generated.

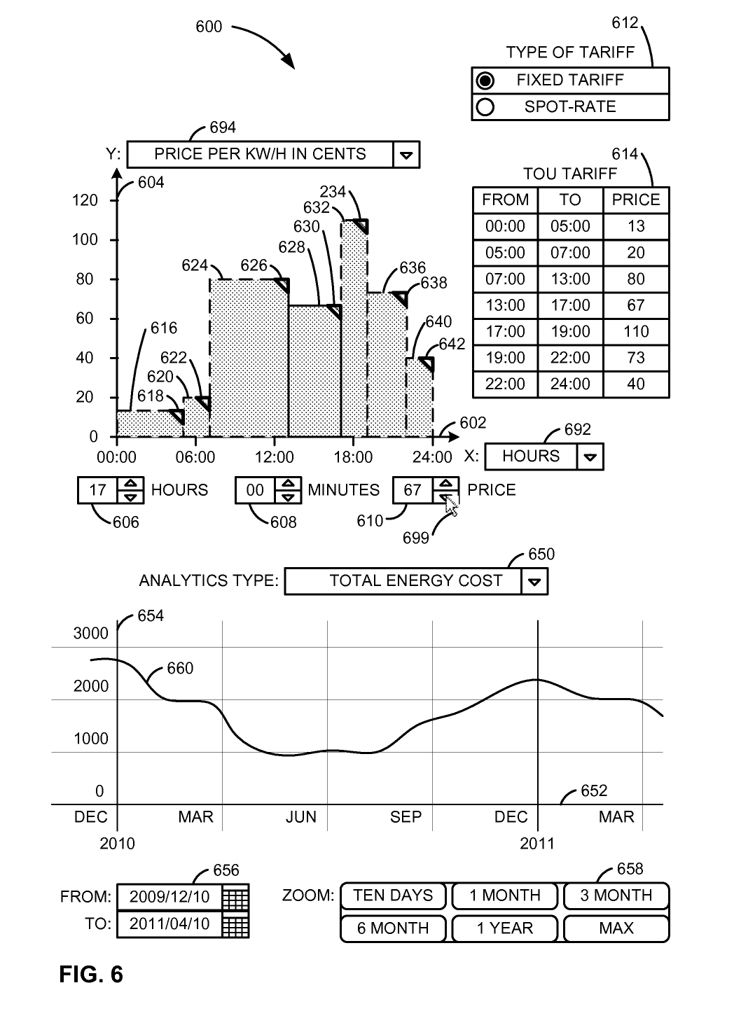

In FIG. 6, GUI 600 is shown containing two main areas, one showing correspondence between selected product characteristics, and another showing score data based on selected analytics type. In both areas of the GUI 600 the information is presented graphically. The correspondence between selected product characteristics is illustrated within Cartesian coordinate system with a line or a number of rectangles corresponding to different segments of correlation between the characteristics. The coordinate system may have one, two or more dimensions where each dimension corresponds to a separate product characteristic.

The coordinate system illustrated in FIG. 6 includes only two dimensions formed by axis X 602 and axis Y 604. In one embodiment, the users may select what characteristics to be presented by axes X and Y by UI select components 692 and 694, respectively. For example, the available select options for a particular product may be provided by UI components 692 and 694 in drop down lists.

As illustrated in FIG. 6, the correspondence between time of use (TOU) in hours and the price of electricity supply per kW/h in cents is illustrated, similar to FIG. 3 to FIG. 5. Once again, fixed tariff is selected using UI component 612, and the designed TOU tariff includes seven segments specified in table 614 and illustrated with rectangles 616, 620, 624, 628, 632, 636 and 640 along axis X 602. The height of each rectangle shows the assigned price for electricity delivery within the timeslot specified by the rectangle width. Again, UI controls 606, 608 and 610 may be used to adjust the data relevant to the current segment, illustrated by rectangle 628 drawn with solid contours. When the width of a segment of the graphical correspondence is changed, it may affect the width of a neighboring segment, or a new segment may be defined.

The visual customization of the tariff may be executed by manipulating, e.g. dragging, UI components 618, 622, 626, 630, 634, 638, and 642 adjacent to their respective tariff segments, e.g., rectangles 616, 620, 624, 628, 632, 636 and 640. In one embodiment, the UI components 618, 622, 626, 630, 634, 638, and 642 may have different form or can be displayed on different positions. The visual customization of the tariff may be also executed by moving the vertical and horizontal boundaries of the corresponding rectangles as appropriate.

The second area of the GUI 600 displays graphic showing a selected analysis or score based on the customized tariff. In the simplified example illustrated with FIG. 6, the score is presented by line 660 along a coordinate system defined by X-axis 652 and Y-axis 654. The type of analytics to be performed based on the customized product parameters (e.g., electricity supply tariff) is selected with UI component 650. UI components 656 and 658 may be displayed only when relevant to the selected analytics type, and may be used for defining the period of the calculated statistics, the scale of displayed details, etc.

The customized product parameters may be used to modify existing business object data, or create new rate objects, according to one embodiment. The data regarding the product characteristics may be stored in database tables or other data structures, e.g., in-memory data files, cookies, etc. The stored information may then be used to calculate scores using the selected analytics type. The score calculations may be further based on statistical information, either historical or forecasted. Based on the calculated scores, the users may further customize the selected product characteristics.

For example, a user may select a value score, e.g., revenue, revenue vs. cost to server, revenue vs. energy cost, etc., and the system will calculate it based on historical consumption data for a certain time period, for specific customer segment, region, etc. Then, based on score simulation results, the user can further adjust the segments and associated price rates.

In one embodiment, score line 660 is automatically drawn in real time in response to any change to the correspondence between the selected product characteristics as illustrated with rectangles 616, 620, 624, 628, 632. 636 and 640. Thus, a user may precisely adjust the product parameters, e.g., by using pointer 699, based on the resulting score. Alternatively, the product parameters may be automatically changed based on user manipulations of the generated score.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

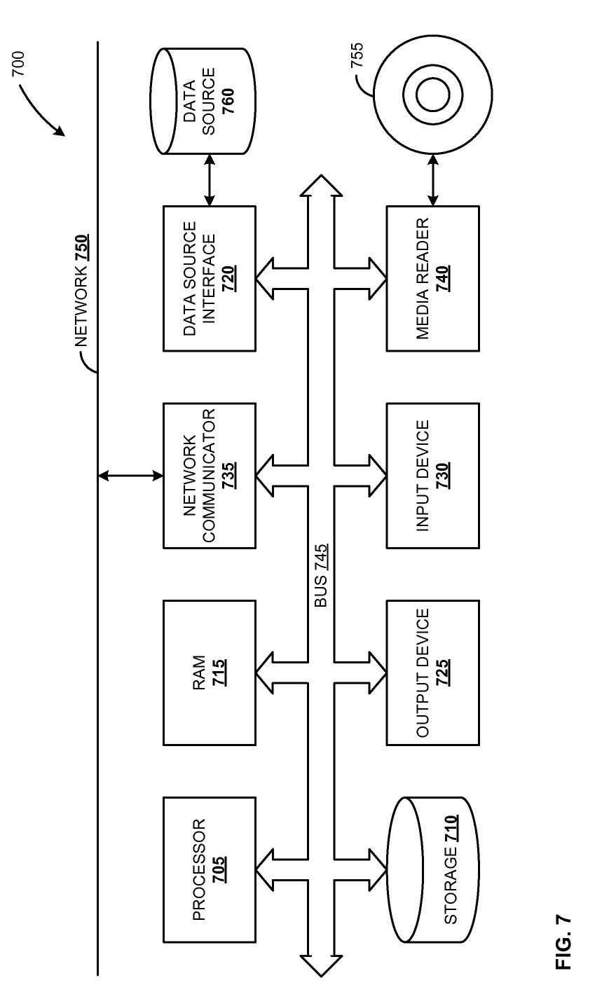

FIG. 7 is a block diagram of an exemplary computer system 700. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed via network 750. In some embodiments the data source 760 may be accessed by an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer system for customizing product parameters comprising:
a processor; and
a memory having instructions stored thereon which when executed by said processor cause the computer system to
render a graphical user interface (GUI) to a display device, the GUI including a GUI pane showing a graphical element representing at least one product characteristic,
receive a manipulation of said graphical element, wherein said manipulation reflects user interaction with an interface device causing a change of position or form of said graphical element within said GUI pane, and
customize said at least one product characteristic in response to said change of position or form of said graphical element.

2. The computer system of claim 1, wherein said memory having instruction stored thereon which when executed by said processor cause the computer system further to
include in said GUI pane a GUI control associated with said graphical element;
receive manipulation of said GUI control, wherein said manipulation reflects user interaction with an interface device; and
customize said at least one product characteristic in response to said manipulation of said GUI control.

3. The computer system of claim 1, wherein the position and form of said graphical element corresponds to at least one value of said at least one product characteristic.

4. The computer system of claim 1, wherein customizing said at least one product characteristic comprises:
store at least one value corresponding to said customized at least one product characteristic in a database.

5. A non-transitory computer readable medium storing instruction thereon, which when executed by a processor cause a computer system to:
display in a graphical user interface (GUI) pane an initial visual representation of a product characteristic;
receive a selection of a GUI control associated with said visual representation of said product characteristic;
receive a manipulation of said GUI control, wherein said manipulation reflects user interaction with an interface device; and
customize at least one segment of said visual representation of said product characteristic in response to said manipulation of said GUI control.

6. The computer readable medium of claim 5 storing instructions thereon, which when executed by a processor cause the computer system further to:
calculate an analytical score based on said at least one segment as customized; and
display said calculated analytical score in said GUI pane.

7. The computer readable medium of claim 5, wherein displaying said initial correspondence comprises:
displaying a graphical element corresponding to at least one initial value of said product characteristic.

8. The computer readable medium of claim 7 storing instructions thereon, which when executed by a processor cause the computer system further to:
display said GUI control associated with said visual representation of said product characteristics adjacent to said graphical element.

9. The computer readable medium of claim 7 storing instructions thereon, which when executed by a processor cause the computer system further to:
receive a manipulation of said graphical element, wherein said manipulation reflects user interaction with an interface device resulting in moving said graphical element in at least one dimension.

10. The computer readable medium of claim 5, wherein receiving said selection of said GUI control comprises:
setting the focus of said GUI pane to said GUI control in response to a predefined system event.

11. The computer readable medium of claim 5, wherein receiving said manipulation of said GUI control comprises:
changing one or more of the form and the position of said GUI control within said GUI pane.

12. The computer readable medium of claim 5, wherein customizing said at least one segment of said correspondence comprises:
storing at least one value reflecting said at least one segment of said visual representation of said product characteristic in a computer memory.

13. In a computer system processing program code to render a graphical user interface (GUI), a method for customizing product parameters comprising:
displaying in a GUI pane an initial correspondence between a plurality of product characteristics;
receiving a selection of a GUI control associated with said correspondence between said plurality of product characteristics;
receiving a manipulation of said GUI control, wherein said manipulation reflects user interaction with an interface device; and
customizing at least one segment of said correspondence between said plurality of product characteristics in response to said manipulation of said GUI control.

14. The method of claim 13 further comprising:
calculating an analytical score based on said at least one segment as customized; and
displaying said calculated analytical score in said GUI pane.

15. The method of claim 13, wherein displaying said initial correspondence comprises:
assigning values of a first characteristic of said plurality of product characteristics to a horizontal axis;
assigning values of a second characteristic of said plurality of product characteristics to a vertical axis; and
displaying at least one graphical element corresponding to a correlation between at least one value of said first characteristic and at least one value of said second characteristic.

16. The method of claim 15 further comprising:
displaying said GUI control associated with said correspondence between said plurality of characteristics adjacent to said at least one graphical element.

17. The method of claim 15 further comprises:
receiving a manipulation of said graphical element, wherein said manipulation reflects user interaction with an interface device resulting in moving said graphical element along one or more of said horizontal axis and said vertical axis.

18. The method of claim 13, wherein receiving said selection of said GUI control comprises:
setting the focus of said GUI pane to said GUI control in response to a predefined system event.

19. The method of claim 13, wherein receiving said manipulation of said GUI control comprises:
changing one or more of the form and the position of said GUI control within said GUI pane.

20. The method of claim 13, wherein customizing said at least one segment of said correspondence comprises:
storing at least one value reflecting said at least one segment of said correspondence in a computer memory.
